(19) United States
(12) Patent Application Publication
(10) Pub. No.: US 2015/0030797 A1
(43) Pub. Date: Jan. 29, 2015

(54) ADHESIVE TAPE AND METHOD OF MANUFACTURING THE SAME

(71) Applicant: AMOGREENTECH CO., LTD., GYEONGGI-DO (KR)

(72) Inventors: In Yong Seo, Seoul (KR); Seung Hoon Lee, Gyeonggi-do (KR); Yong Sik Jung, Gyeonggi-do (KR); Yun Mi So, Daejeon (KR)

(21) Appl. No.: 14/382,590

(22) PCT Filed: Feb. 22, 2013
(86) PCT No.: PCT/KR2013/001445

§ 371 Date: Sep. 3, 2014

(30) Foreign Application Priority Data
Mar. 6, 2012 (KR) 10-2012-0022671

(51) Int. Cl. C09J 7/02; D04H 13/00; C09J 7/04; B32B 5/24; D01D 5/00; D04H 1/728; B32B 5/26

(52) U.S. Cl. CPC C09J 7/0285; D04H 1/728; D04H 13/00; B32B 5/26; B32B 5/24; D01D 5/0007; C09J 7/04; B32B 2405/00; D10B 2331/10; D10B 2331/04; C09J 2467/006; C09J 2201/128
USPC 428/41.8; 442/382; 442/401; 442/340; 442/346; 442/395; 264/10

(57) ABSTRACT

Provided is an adhesive tape including: a substrate; and an adhesive layer laminated on one surface or both surfaces of the substrate, wherein one or both of the substrate and the adhesive layer are produced in a nano-web form in which fiber strands are captured by a spinning method. Thus, the adhesive tape can be made thin, and an adhesive strength can be improved. In addition, the adhesive tape can be precisely attached on a corrugated surface. When the adhesive tape attached between components is separated from the components, the adhesive layers can be prevented from remaining on the surfaces of the components.

### TECHNICAL FIELD

The present invention relates to an adhesive tape having an adhesive layer on one surface or both surfaces of the adhesive tape, and more particularly, to an adhesive tape that is manufactured by an electrospinning method, and a method of manufacturing the same.

### BACKGROUND ART

In general, double-sided adhesive tapes are currently widely used to secure internal components in a variety of electronic apparatuses such as mobile terminals and portable electronic devices.

At present, double-sided adhesive tapes are being developed in the direction for enhancing the adhesive strength while reducing the thickness in accordance with the trend of slim, compact and light-weight portable electronic apparatuses.

A substrate for reinforcing adhesive strength of a double-sided adhesive tape may be provided in the middle of the double-sided adhesive tape. Double-sided adhesive tapes may be classified into a substrate type double-sided adhesive tape in which an adhesive layer is laminated on either side of a substrate, and a non-substrate type double-sided adhesive tape which includes only an adhesive layer without using a substrate.

The substrate type double-sided adhesive tape has an advantage of enhancing the strength of the tape. However, the substrate type double-sided adhesive tape is thicker due to the presence of the substrate, and adhesion strength between the substrate and the adhesive layer is reduced due to the smooth surface of the substrate, to thereby cause separation between the substrate and the adhesive layer.

In particular, in the case of separating components that are attached to each other by the double-sided adhesive tape, the substrate and the adhesive layer are separated from each other, to thereby cause the adhesive layer to be attached on the surfaces of the components.

In addition. the non-substrate type double-sided adhesive tape has no strength enhancement layer, and thus it is difficult to maintain an original shape. Accordingly, when the non-substrate type double-sided adhesive tape is adhered between components, the non-substrate type double-sided adhesive tape may be pushed or folded, to thus cause it difficult to perform precise attachment of the components. In addition, an air layer is formed between the adhesive layer and each of the components, to thus cause less adhesive strength.

In this way, since thickness of the substrate should be thin when the double-sided adhesive tape is thinly produced, the production cost is increased and the adhesive strength is lowered. Then, separation between the substrate and the adhesive layer may occur due to the smooth surface of the substrate.

As described in Korean Patent Application Publication No. 10-2010-0112528 (Oct. 19, 2010), the conventional double-sided adhesive tape has the structure of having an adhesive layer on either surface of a foam substrate in which a plurality of air bubbles are formed in the foam substrate.

Since the conventional double-sided adhesive tape includes a substrate formed of foams, the adhesive strength between the adhesive layer and the substrate is enhanced to thereby prevent the adhesive layer and the substrate from being separated from each other.

However, since the conventional double-sided adhesive tape includes a substrate formed of foams, the substrate becomes thick and thus the double-sided adhesive tape becomes thick.

### DISCLOSURE

### Technical Problem

To solve the above problems or defects, it is an object of the present invention to provide an adhesive tape and a method of manufacturing the same in which one or both of a substrate and an adhesive layer are produced by a spinning method, so that the adhesive tape can be made thin, and can be made to have a variety of thicknesses.

It is another object of the present invention to provide an adhesive tape and a method of manufacturing the same in which a substrate is produced in a nano-web form having a plurality of pores by a spinning method, to thus improve flexibility so that the adhesive tape can be precisely attached on a corrugated surface.

It is still another object of the present invention to provide an adhesive tape and a method of manufacturing the same in which since an adhesive material is introduced into a plurality of pores formed in a substrate, the amount of an adhesive can be increased, to thus improve an adhesive strength.

The technical solutions in the present invention are not limited to the above-mentioned technical solutions and the other technical solutions that are not mentioned here will become understood apparently by those skilled in the art from the following description of the invention.

### Technical Solution

To accomplish the above and other objects of the present invention, according to an aspect of the present invention, there is provided an adhesive tape comprising:

a substrate; and an adhesive layer laminated on one surface or both surfaces of the substrate, wherein one or both of the substrate and the adhesive layer are produced in a nano-web form in which fiber strands are captured by a spinning method.

According to another aspect of the present invention, there is provided an adhesive tape comprising:

a substrate that is produced in a nano-web form in which ultra-fine fibers are accumulated by a spinning method;

a third adhesive layer that is laminated by spinning an adhesive material on one or either surface of the substrate; and

a fourth adhesive layer that is laminated by spinning the adhesive material on a surface of the third adhesive layer,

wherein the third adhesive layer is formed of an adhesive material having a viscosity higher than the fourth adhesive layer.

According to another aspect of the present invention, there is provided an adhesive tape comprising:

a substrate that is produced in a nano-web form in which ultra-fine fibers are accumulated by a spinning method;

a non-pore substrate that is laminated on one surface or both surfaces of the substrate; and

an adhesive layer laminated on a surface of the non-pore film layer.

According to another aspect of the present invention, there is provided a method of manufacturing an adhesive tape, the method comprising:

forming a first adhesive layer by spinning an adhesive material;

forming a substrate by spinning a polymer material on a surface of the first adhesive layer; and

forming a second adhesive layer by spinning the adhesive material on a surface of the substrate.

According to another aspect of the present invention, there is provided a method of manufacturing an adhesive tape, the method comprising:

forming an adhesive layer by spinning an adhesive material;

forming a substrate by spinning a polymer material; and

mutually combining the adhesive layer on one surface or both surfaces of the substrate.

According to another aspect of the present invention, there is provided a method of manufacturing an adhesive tape, the method comprising:

preparing a substrate made of a non-woven fabric or non-pore type resin film;

forming a first adhesive layer by spinning an adhesive material on one surface of the substrate; and

forming a second adhesive layer by spinning the adhesive material on the other surface of the substrate.

According to another aspect of the present invention, there is provided a method of manufacturing an adhesive tape, the method comprising:

forming a substrate by spinning a polymer material;

forming a third adhesive layer by spinning an adhesive material having a high viscosity on one surface or both surfaces of the substrate; and

forming a fourth adhesive layer by spinning an adhesive material having a viscosity lower than the third adhesive layer on a surface of the third adhesive layer.

### ADVANTAGEOUS EFFECTS

As described above, an adhesive tape according to the present invention is configured in a nano-web form, by spinning one or both of a substrate and an adhesive layer, to thus form ultra-fine fiber strands, and accumulating the ultra-fine fiber strands, so that the adhesive tape can be made thin, and can be adjusted at a desired thickness, to thus improve an adhesive strength.

An adhesive tape is provided, in which a substrate is produced in a nano-web form having a plurality of pores by a spinning method, to thus improve flexibility an that the adhesive tape can be precisely attached on a corrugated surface.

An adhesive tape is provided, in which since an adhesive material is introduced into a plurality of pores formed in a substrate, the amount of an adhesive can be increased, to thus improve an adhesive strength.

### DESCRIPTION OF DRAWINGS

FIG. 1 is a cross-sectional view of an adhesive tape according to a first embodiment of the present invention.

FIG. 2 is an enlarged cross-sectional view of the adhesive tape according to the first embodiment of the present invention.

FIG. 3 is a photo view enlarging surface of a substrate according to the first embodiment of the present invention.

FIG. 4 is a cross-sectional view of an adhesive tape according to a second embodiment of the present invention.

FIG. 5 is a cross-sectional view of an adhesive tape according to a third embodiment of the present invention.

FIG. 6 is a block diagram of a configuration of an electrospinning apparatus for manufacturing an adhesive tape according to the present invention.

FIG. 7 is a cross-sectional view of an adhesive tape according to a fourth embodiment of the present invention.

FIG. 8 is a block diagram of a configuration of an electrospinning apparatus for manufacturing an adhesive tape according to the fourth embodiment of the present invention.

FIG. 9 is a cross-sectional view of an adhesive tape according to a fifth embodiment of the present invention.

### BEST MODE

Embodiments of the present invention will be described in detail with reference to the accompanying drawings. The size or shape of the components illustrated in the drawings in this case may be shown to be exaggerated for convenience of illustration and clarity. In addition, specifically defined terms may be changed according to the intention of users or operators or practices in consideration of the configuration and operation of the present invention. The definition of the terms should be given according to the contents throughout the present specification.

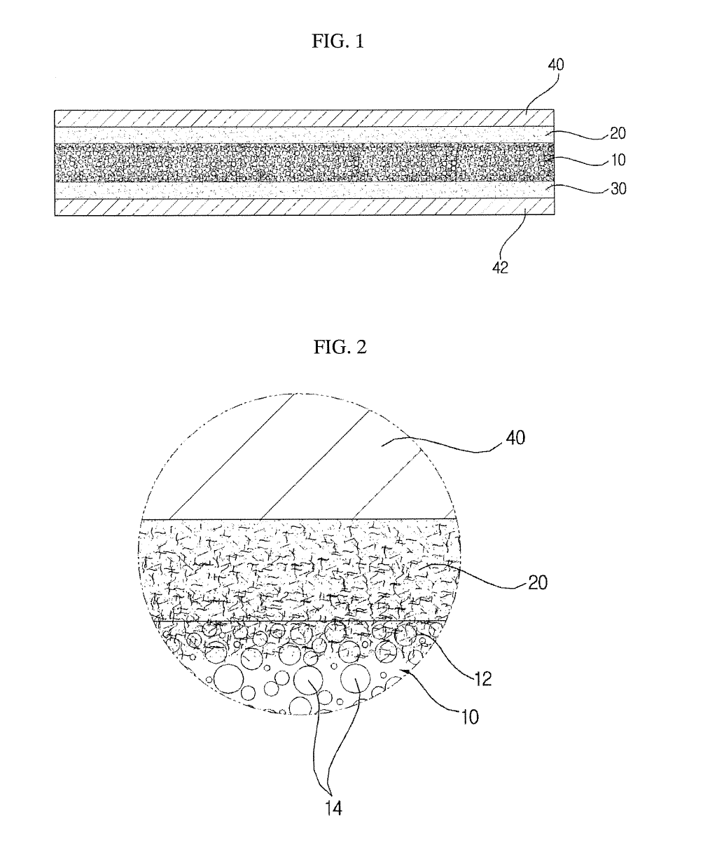

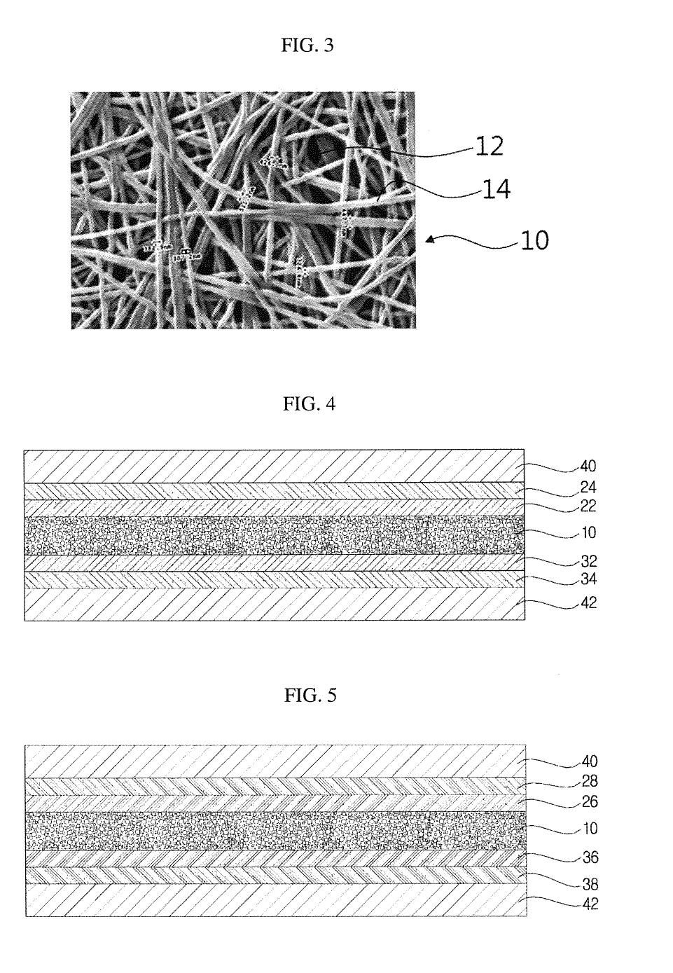

FIG. 1 is a cross-sectional view of an adhesive tape according to a first embodiment of the present invention. FIG. 2 is an enlarged cross-sectional view of the adhesive tape according to the first embodiment of the present invention. FIG. 3 is a photo view enlarging surface of a substrate according to the first embodiment of the present invention.

Referring to FIGS. 1 to 3, an adhesive tape according to a first embodiment of the present invention includes: a substrate 10 that is formed to have a predetermined thickness, in a nano-web shape in which ultra-fine fiber strands 14 are made by a spinning method, and the ultra-fine fiber strands 14 are accumulated; and an adhesive layer 20 that is laminated on one surface of the substrate 10, or adhesive layers 20 and 30 that are respectively laminated on both surfaces of the substrate 10.

The substrate 10 is fabricated in a nano-web shape having a large number of pores 12 by making ultra-fine fiber strands 14 through a spinning method of a polymer material and accumulating the ultra-fine fiber strands 14.

The diameter of one of the fiber strands 14 is preferably in a range of 0.1-3.0 μm. Here, the spinning method that is applicable in this invention may be any one of general electrospinning, air-electrospinning (AES), electrospray, electrobrown spinning, centrifugal electrospinning, and flash-electrospinning.

That is, the substrate 10 and the adhesive layers 20 and 30 may be formed by using any spinning method among the spinning methods by which the substrate 10 and the adhesive layer 20 and 30 can be made in a form where the ultra-fine fiber strands are accumulated.

The polymer material that is used to make the substrate 10 may be, for example, polyvinylidene fluoride (PVDF), poly (vinylidene fluoride-co-hexafluoropropylene), perfluoropolymer, polyvinyl chloride or polyvinylidene chloride, and copolymers thereof, a polyethylene glycol derivative comprising polyethylene glycol dialkyl ether and polyethylene glycol dialkyl ester, poly-oxide comprising poly (oxymethylene-oligo-oxyethylene), polyethylene oxide and polypropylene oxide, polyacrylonitrile copolymer comprising polyvinyl acetate, poly (vinylpyrrolidone-vinyl acetate), polystyrene and polystyrene acrylonitrile copolymer, and polyacrylonitrile methyl methacrylate copolymer, polymethyl methacrylate and polymethyl methacrylate copolymer, and mixtures thereof.

Since the substrate 10 is fabricated by using the electrospinning method, thickness of the substrate 10 is determined according to a dose of the spun polymer material. Thus, the substrate 10 may be advantageously made in a desired thickness. In other words, it is possible to slim the thickness of the substrate 10 when a dose of the spun polymer material is made small. In addition, since a dose of the spun polymer material is small, the manufacturing cost can be reduced so much.

When a dose of the spun polymer material is increased, thickness of the substrate 10 becomes large, and strength of the substrate 10 can be increased.

In this way, since the substrate 10 may be fabricated in a nano-web shape having a large number of pores 12 by electrospinning a polymer material to thereby make ultra-fine fiber strands 14 and accumulating the ultra-fine fiber strands 14 in a predetermined thickness, the adhesive tape can be made thin and further can be made to have a variety of thicknesses, while reducing the manufacturing cost.

In addition, since the substrate 10 is fabricated in a nano-web shape in which ultra-fine fiber strands 14 are accumulated, the substrate 10 has flexibility. Thus, the adhesive tape can be precisely attached to even a portion where a surface to which the adhesive tape is attached is formed in a staircase or corrugated shape.

That is, in the case of the substrate used in the conventional double-sided adhesive tape, the substrate 10 has poor flexibility. Thus, when the adhesive tape is attached on the surface of the staircase shape or the corrugated portion, the adhesive tape is detached from the surface of the staircase shape or the corrugated portion by rigidity of the substrate. Accordingly, an air layer is formed at a portion where the adhesive tape is detached, thus lowering the adhesive strength of the adhesive tape. However, the substrate 10 according to the present embodiment has excellent flexibility because of a nano-web form to thus solve the problems of the conventional adhesive tape.

Further, since the substrate 10 is fabricated in a nano-web shape in which the ultra-fine fiber strands 14 are accumulated, the tensile strength of the substrate 10 is strong to thereby prevent the substrate 10 from being torn by force exerted from the outside and although the substrate 10 is made thin, the substrate 10 has a sufficient rigidity.

The adhesive layers 20 and 30 may include a first adhesive layer 20 that is stacked on one surface of the substrate 10, and a second adhesive layer 30 that is stacked on the other surface of the substrate 10. Otherwise, an adhesive layer may be stacked on only one surface of the substrate 10.

The adhesive layers 20 and 30 are prepared in the same way as an electrospinning method that is used for making the substrate 10. In other words, an adhesive material is prepared to have a viscosity suitable for electrospinning by a mixture of an adhesive and a solvent, and the adhesive material is laminated in a predetermined thickness on the surface of the substrate 10 by using the electrospinning method.

Here, the adhesive layers 20 and 30 are separately prepared in a spinning manner, and the substrate 10 is separately prepared in the spinning manner. Then, the first adhesive layer 20 is disposed on one surface of the substrate 10, and the second adhesive layer 30 is disposed on the other surface of the substrate 10. Then, each of the adhesive layers 20 and 30 and the substrate 10 are coupled with each other by, for example, a thermocompression bonding method.

The thickness of each of the adhesive layers 20 and 30 is determined in accordance with a dose of the spun adhesive material. Therefore, it is possible to make each of the adhesive layers 20 and 30 in a desired thickness.

In addition, the adhesive layers 20 and 30 are spun in the form of ultra-fine fiber strands, and respectively adhered on both the surfaces of the substrate 10. Here, the adhesive material is introduced into the pores 12 of the substrate 10, and thus increases an adhesive strength between each of the adhesive layers 20 and 30 and the substrate 10. As well, the adhesive layers 20 and 30 are introduced into the pores 12 of the substrate 10, and thus increases the amount of the adhesive. Accordingly, in the case that a double-sided adhesive tape according to the present embodiment has the same thickness as the conventional double-sided adhesive tape, the former has the more amount of the adhesive than the latter, to thereby increase the adhesive strength as much as the amount of the adhesive.

The first adhesive layer 20 and the second adhesive layer 30 may be formed into the adhesive layers having an identical adhesive strength. In other words, when the two adhesive layers have an identical adhesive strength, it is preferable to use the two adhesive layers at regions from which they do not need to detach once they are attached thereon.

Also, the adhesive layers 20 and 30 can be formed so that one has a slightly poorer adhesive strength than the other. That is, in one embodiment, the adhesive strength of the first adhesive layer 20 is formed higher than that of the second adhesive layer 30, and thus after the adhesive layers 20 and 30 are attached on both the surfaces of the substrate 10, it is preferable to use the second adhesive layer 30 at a region from which it is easily detached and to which it is attached again.

A first release film 40 for protecting the first adhesive layer 20 is attached on the surface of the first adhesive layer 20, and a second release film 42 for protecting the second adhesive layer 30 is attached on the surface of the second adhesive layer 30.

The first release film 40 and the second release film 42 are formed of a different material to each other. In one embodiment, the first release film 40 is formed of a paper material and the second release film 42 is formed of a synthetic resin material.

Here, the reason why the first release film 40 and the second release film 42 are formed of a different material to each other is to make an attachment force between the first release film 40 and the first adhesive layer 20, and an attachment force between the second release film 42 and the second adhesive layer 30 differ from each other.

The reason for this is to prevent the second release film 42 from being peeled away from the second adhesive layer 30 when the first release film 40 is peeled away from the first adhesive layer 20 in order to make the first adhesive layer 20 attached on a component.

In other words, if the second release film 42 is peeled away from the second adhesive layer 30 when the first release film 40 is peeled away from the first adhesive layer 20, the second adhesive layer 30 may damage. In order to prevent damage to the adhesive layer, the attachment force between the first release film 40 and the first adhesive layer 20, and the attachment force between the second release film 42 and the second adhesive layer 30 can be formed differently to each other.

FIG. 4 is a cross-sectional view of an adhesive tape according to a second embodiment of the present invention.

Referring to FIG. 4, the adhesive tape according to the second embodiment of the present invention is used for a portion where strength of a substrate 10 is strongly required, and includes: the substrate 10 having a nano-web form of a predetermined thickness in which ultra-fine fibers are accumulated by a spinning method; a third adhesive layer 22 or 32 that is laminated on one surface of the substrate 10 or third adhesive layers 22 and 32 that are respectively laminated on both surfaces of the substrate 10; and a fourth adhesive layer 24 or 34 that is laminated on a surface of the third adhesive layer 22 or 32, or fourth adhesive layers 24 and 34 that are laminated on respective surfaces of the third adhesive layers 22 and 32.

The third adhesive layers 22 and 32 have a relatively high viscosity, respectively, and the fourth adhesive layer 24 and 34 have a relatively lower viscosity than the third adhesive layers 22 and 32.

In the case that a high viscosity of an adhesive layer is laminated on the surface of the substrate 10, a relatively small amount of an adhesive material is absorbed into the pores 12 formed in the substrate 10. Accordingly, the shape of the substrate 10 is easily maintained, and thus the strength of the substrate 10 can be made stronger.

Accordingly, the strength of the substrate 10 is reinforced by laminating a high viscosity of the third adhesive layers 22 and 32 on both the surfaces of the substrate 10.

In addition, when the viscosity of the adhesive layer is high, the adhesive strength is reduced. In order to prevent the adhesive strength from decreasing, a low viscosity of the fourth adhesive layers 24 and 34 are laminated on the respective surfaces of the high viscosity of the third adhesive layers 22 and 32, to thus enhance the adhesive strength.

In the case of the adhesive tape according to the second embodiment, the high viscosity of the third adhesive layers 22 and 32 are laminated on both the surfaces of the substrate 10, to thus reinforce the strength of the substrate 10, and the low viscosity of the fourth adhesive layers 24 and 34 are respectively laminated on both the surfaces of the high viscosity of the third adhesive layers 22 and 32, to thus reinforce the adhesive strength.

FIG. 5 is a cross-sectional view of an adhesive tape according to a third embodiment of the present invention.

Referring to FIG. 5, the adhesive tape according to the third embodiment of the present invention is used for a portion where strength of a substrate 10 is strongly required, like the adhesive tape according to the second embodiment of the present invention, and includes: a substrate 10 having a nano-web form of a predetermined thickness in which ultra-fine fibers are accumulated by a spinning method; a non-porous film layer 26 or 36 that is laminated on a surface of the substrate 10 or non-porous film layers 26 and 36 that are respectively laminated on both surfaces of the substrate 10; and an adhesive layer 28 or 38 that is laminated on a surface of the non-porous film layer 26 or 36, or adhesive layers 28 and 38 that are laminated on surfaces of the respective non-porous film layers 26 and 36.

The non-porous film layers 26 and 36 are formed in a non-porous form having no pores without a separate heat treatment in which PU (Polyurethane) or TPU (Thermoplastic polyurethane) is melted in a solvent when a polymer material containing the PU or TPU is made into ultra-fine fiber strands by an electrospinning method and then ultra-fine fiber strands are accumulated.

That is, the non-porous film layers 26 and 36 are formed in a non-porous film form having no pores, in which PU or TPU is melted in a solvent when a polymer material containing a rubber component such as the PU or TPU that is melted in the solvent is used and electrospun.

When the non-porous film layers 26 and 36 are laminated on the surface of the substrate 10, the adhesive material is not absorbed into pores 12 formed in the substrate 10, to thus reinforce the strength of the substrate 10.

The adhesive layers 28 and 38 are formed of a low viscosity of the adhesive layers to improve an adhesive strength.

In this way, in the case of the adhesive tape according to the third embodiment, the non-porous film layers 26 and 36 are laminated between the substrate 10 and each of the adhesive layers 28 and 38, to thus prevent the adhesive materials of the adhesive layers 28 and 38 from being absorbed into the pores 12 of the substrate 10 and to thereby enhance the strength of the substrate 10.

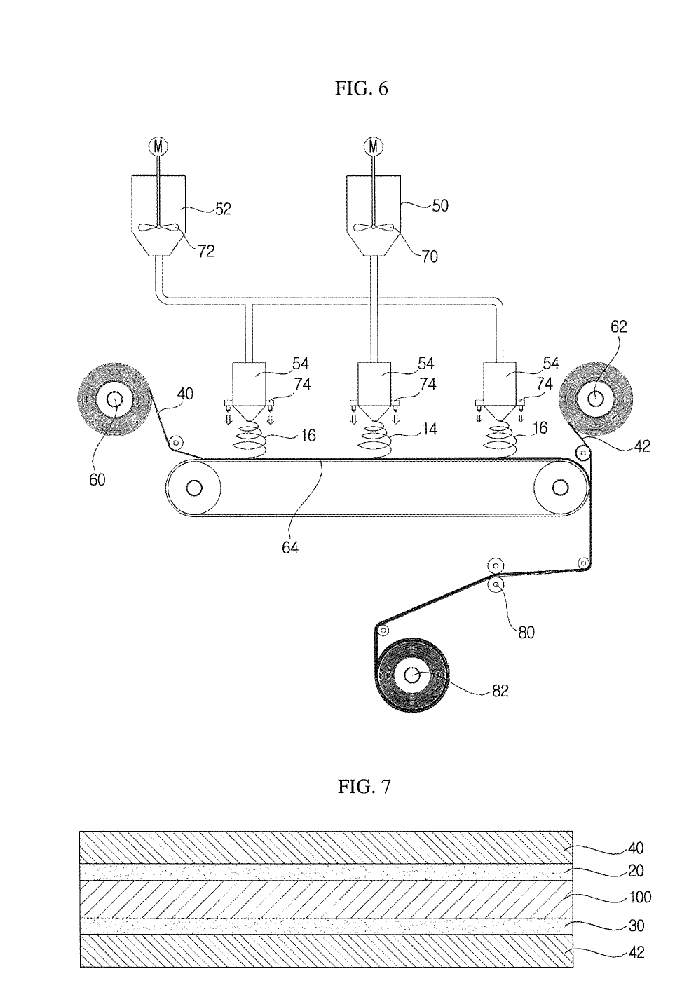

FIG. 6 is a block diagram of a configuration of an electrospinning apparatus for manufacturing an adhesive tape according to an embodiment of the present invention.

Referring to FIG. 6 in addition to FIG. 1, the electrospinning apparatus according to the present invention includes: a first mixing tank 50 in which a polymer material and a solvent are mixed and stored; a second mixing tank 52 in which an adhesive and a solvent are mixed and stored; a first spinning nozzle 54 that is connected to a high voltage generator and the second mixing tank 52, and forms a first adhesive layer 20; a second spinning nozzle 56 that is connected to a high voltage generator and the first mixing tank 50, and forms a substrate 10; and a third spinning nozzle 58 that is connected to a high voltage generator and the second mixing tank 52, and forms a second adhesive layer 30.

The first mixing tank 50 is provided with a first agitator 70 that evenly mixes the polymer material and the solvent and maintains a constant viscosity of the polymer material, and the second mixing tank 52 is provided with a second agitator 72 that evenly mixes the adhesive and the solvent and maintains a constant viscosity of the adhesive material.

A collector 64 is provided below the first through third spinning nozzles 54, 56, and 58, in which the collector 64 enables the first adhesive layer 20, the substrate 10, and the second adhesive layer 30 to be sequentially laminated on one another. In addition, a high voltage electrostatic force of 90 to 120 Kv is applied between the collector 64 and each of the spinning nozzles 54, 56, and 58, to thereby spin ultra-fine fiber strands 14 and 16, and to thus form an ultra-fine nano-web.

Here, the first spinning nozzle 54, the second spinning nozzle 56, and the third spinning nozzle 58 are arranged in the form of a plurality of spinning nozzles, respectively, in which the plurality of spinning nozzles may be arranged in sequence in a chamber or may be arranged in different chambers, respectively.

The first spinning nozzle 54, the second spinning nozzle 56, and the third spinning nozzle 58 are provided with an air spray apparatus 74, respectively, to thereby prevent the fiber strands 14 and 16 spun from the first spinning nozzle unit 54, the second spinning nozzle 56, and the third spinning nozzle 58 from fluttering without being smoothly collected to the collector 64.

The multi-hole spin pack nozzles used in the present invention are made to set air pressure of air spraying to be in the range of about 0.1 to about 0.6 MPa. In this case, air pressure that is less then about 0.1 MPa, does not contribute to capture and integrate the fiber strands. In the case that air pressure exceeds about 0.6 MPa, the cone of each spinning nozzle is hardened to thus cause a clogging phenomenon of the needle to occur and to thereby cause a spinning trouble to occur.

A conveyor that automatically transfers a first release film 40 may be used as the collector 64, in order to make the first adhesive layer 20, the substrate 10, and the second adhesive layer 30 sequentially laminated on the first release film 40. Otherwise, a table may be used as collector 64, in order to make the first adhesive layer 20, the substrate 10, and the second adhesive layer 30 formed in respectively different chambers.

A first release film roll 60 around which the first release film 40 is wound is disposed in the front side of the collector 64, to thus feed the first release film 40 onto the top surface of the collector 64. In addition, a second release film roll 62 around which a second release film 42 is wound is disposed in the rear side of the collector 64, to thus feed the second release film 42 attached on a surface of the second adhesive layer 30.

A pressure roller 80 that pressurizes (or calenders) the first adhesive layer 20, the substrate 10, and the second adhesive layer 30 to have a constant thickness is provided at one side of the collector 64. A tape roll 82 is provided, around which the adhesive tapes pressurized via the pressure roller 80 are wound.

A process for producing an adhesive tape by using an electrospinning apparatus as described above will be described as follows.

First, when the collector 64 is driven, the first release film 40 wound on the first release film roll 60 is released and moved along the top surface of the collector 64.

Then, a high voltage electrostatic force is applied between the collector 64 and the first spinning nozzle 54, and thus the adhesive material is made into ultra-fine fiber strands 16 by the first spinning nozzle 54 to then be spun to the top surface of the first release film 40. As a result, the ultra-fine fiber strands 16 are accumulated onto the surface of the first release film 40 to thus form the first adhesive layer 20 in a non-pore film shape.

Here, when the first spinning nozzle 54 spins the fiber strands 16, the air spray apparatus 74 mounted in the first spinning nozzle 54 sprays air to the fiber strands 16, so that the fiber strands 16 can be collected and captured on the surface of the first release film 40.

Then, when the first adhesive layer 20 is completely manufactured, the first adhesive layer 20 is moved to the bottom of the second spinning nozzle 56, and when a high voltage electrostatic force is applied between the collector 64 and the second spinning nozzle 56, the polymer material is made into ultra-fine fiber strands 14 by the second spinning nozzle 56 to then be spun on the first adhesive layer 20. As a result, the substrate 10 is formed onto the surface of the first adhesive layer 20 in an ultra-fine nano-web shape having a large number of pores 12.

In addition, when the substrate 10 is completely manufactured, the substrate 10 is moved to the bottom of the third spinning nozzle 58, and when a high voltage electrostatic force is applied between the collector 64 and the third spinning nozzle 58, the adhesive material is made into ultra-fine fiber strands 16 by the third spinning nozzle 58 to then be spun on the substrate 10. As a result, the second adhesive layer 30 is formed onto the surface of the substrate 10 in a non-pore film shape.

In addition, the second release film 42 wound on the second release film roll 62 is covered on the surface of the second adhesive layer 30. In this way, the completed adhesive tape is wound on the tape roll 82 after being pressurized in a predetermined thickness as it passes through the pressure roller 80.

Here, in the case that only one adhesive layer is provided in the substrate 10, a process of forming the second adhesive layer is omitted.

The first adhesive layer 20 and the second adhesive layer 30 may be formed to have an identical adhesive strength, or any one of the two adhesive layers 20 and 30 may be formed to have a weaker adhesive strength than the other of the two adhesive layers 20 and 30.

Further, in addition to the above-described method, the following method may be applicable in which the substrate 10 and the adhesive layers 20 and 30 are each separately produced, and then the first adhesive layer 20 is disposed on one surface of the substrate 10 while the second adhesive tape 30 is disposed on the other surface of the substrate 10, to then mutually combining the substrate 10 with the second adhesive tape 30 and to thus produce the adhesive tap.

In addition, referring to FIG. 4, when the adhesive tape according to the second embodiment is manufactured as described above, the above-described electrospinning apparatus is used in order that a high viscosity of third adhesive layers 22 and 32 are respectively laminated on both surfaces of the substrate 10 and a low viscosity of fourth adhesive layers 24 and 34 are laminated on respective surfaces of the third adhesive layers 22 and 32. However, alternatively, a high viscosity of third adhesive layer 22 or 32 may be laminated on one surface of the substrate 10, or a low viscosity of a fourth adhesive layer 24 or 34 is laminated on a surface of the third adhesive layer 22 or 32.

Further, in addition to the above-described method, the following method may be applicable in which the substrate 10, the third adhesive layers 22 and 32, the fourth adhesive layers 24 and 34 are each separately produced, and then the substrate 10, the third adhesive layers 22 and 32, the fourth adhesive layers 24 and 34 are mutually combined in a subsequent process, to thereby produce the adhesive tape.

In addition, referring to FIG. 5, when the adhesive tape according to the third embodiment is manufactured as described above, non-porous film layers 26 and 36 are respectively laminated on both surfaces of the substrate 10; and adhesive layers 28 and 38 are laminated on surfaces of the respective non-porous film layers 26 and 36. However, alternatively, a non-porous film layer 26 or 36 is laminated on a surface of the substrate 10 and an adhesive layer 28 or 38 is laminated on a surface of the non-porous film layer 26 or 36.

Here, the non-porous film layers 26 and 36 are formed in a non-porous form having no pores by electrospinning a polymer material containing the PU or TPU.

FIG. 7 is a cross-sectional view of an adhesive tape according to a fourth embodiment of the present invention.

Referring to FIG. 7, the adhesive tape according to the fourth embodiment of the present invention includes a resin film 100 as a substrate in which the resin film 100 is widely used as a substrate of an existing double-sided tape. In addition, a first adhesive layer 20 and a second adhesive layer 30 are respectively formed on both surfaces of the resin film 100 by using the electrospinning method in the same manner as the first embodiment of the present invention.

It is preferable that a PET (Polyethylene terephthalate) film is used as the resin film 100. It is also possible to use a non-woven fabric having a plurality of pores as the resin film 100, in addition to the PET film.

Since the first adhesive layer 20 and the second adhesive layer 30 are the same as those of the first embodiment, the detailed description thereof will be omitted.

FIG. 8 is a block diagram of a configuration of an electrospinning apparatus for manufacturing an adhesive tape according to the fourth embodiment of the present invention.

Referring to FIG. 8, the electrospinning apparatus for manufacturing an adhesive tape according to the fourth embodiment of the present invention includes: a first collector 110 on which a resin film 100 is transported; a first spinning nozzle unit 120 that is disposed above the first collector 110, and that is connected to a high voltage generator, to thus form a first adhesive layer 20 on one surface of the resin film 100; a second collector 130 on which the other surface of the resin film 100 on the one surface of which the first adhesive layer 20 is formed is transported upward; and a second spinning nozzle unit 140 that is disposed above the second collector 130, and that is connected to a high voltage generator, to thus form a second adhesive layer 30 on the other surface of the resin film 100.

A resin film roll 150 around which the resin film 100 is wound is disposed in the front side of the first collector 110, a first release film roll 160 around which the first release film 40 that is attached on a surface of the first adhesive layer 20 is wound is disposed in the rear side of the first collector 110, and a second release film roll 170 around which the second release film 42 that is attached on a surface of the second adhesive layer 30 is wound is disposed in the rear side of the second collector 130.

Here, since the structures of the first collector 110, the second collector 130, the first spinning nozzle unit 120, and the second spinning nozzle unit 140 are the same as those of the collector 64 and the first spinning nozzle 54 of the first embodiment, the detailed description thereof will be omitted.

A process for producing an adhesive tape by using an electrospinning apparatus according to the fourth embodiment of the present invention will be described as follows.

First, when the first collector 110 is driven, the resin film 100 wound on the resin film roll 150 is moved along the top surface of the first collector 110.

Then, a high voltage electrostatic force is applied between the first collector 110 and the first spinning nozzle unit 120, and thus the adhesive material is made into ultra-fine fiber strands 16 by the first spinning nozzle unit 120 to then be spun to one surface of the resin film 100. As a result, the ultra-fine fiber strands 16 are accumulated onto the one surface of the resin film 40 to thus form the first adhesive layer 20 in a non-pore film shape.

In addition, when the first adhesive layer 20 is completely manufactured, the first release film 40 wound on the first release film roll 160 is covered on the surface of the first adhesive layer 20.

In this way, when the process of laminating the first adhesive layer 20 on one surface of the resin film 100 is completed, a process of laminating the second adhesive layer 30 on the other surface of the resin film 100 is executed.

That is, the resin film 100 on which first adhesive layer 20 has been laminated is moved to the second collector 130. Here, since the second collector 130 is placed on the lower side of the first collector 110, the resin film 100 is moved to the second collector 130 in an inverted state where the resin film 100 has been inverted upside down. Accordingly, the other surface of the resin film 100 is transported upward on the second collector 130.

Then, a high voltage electrostatic force is applied between the second collector 130 and the second spinning nozzle unit 140, and thus the adhesive material is made into ultra-fine fiber strands by the second spinning nozzle unit 140 to then be spun to the other surface of the resin film 100. As a result, the ultra-fine fiber strands are accumulated onto the other surface of the resin film 100 to thus form the second adhesive layer 30 in a non-pore film shape.

In addition, when the second adhesive layer 30 is completely manufactured, the second release film 42 wound on the second release film roll 170 is covered on the surface of the second adhesive layer 30.

In this way, the completed adhesive tape is wound on the tape roll 190 after being pressurized in a predetermined thickness as it passes through the pressure roller 180.

In addition to the above-described method as the method of manufacturing the adhesive tape according to the fourth embodiment, a method of mutually combining an adhesive layer and a resin film after separately preparing the adhesive layer and the resin film is also applicable.

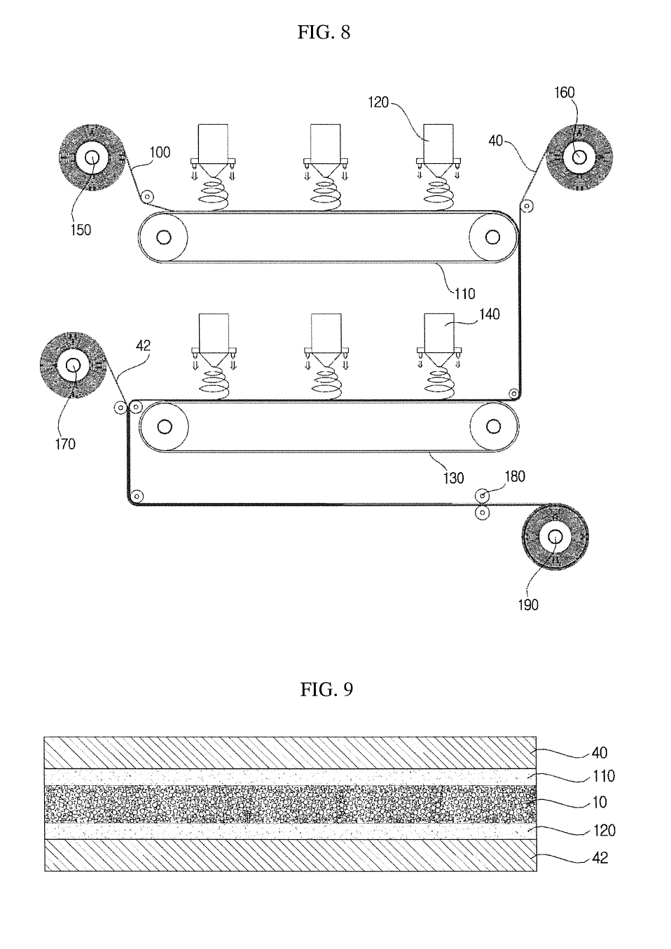

FIG. 9 is a cross-sectional view of an adhesive tape according to a fifth embodiment of the present invention.

Referring to FIG. 9, the adhesive tape according to the fifth embodiment includes a substrate 10 that is prepared in a nano-web form having a plurality of pores 12 by the same electrospinning method as the substrate 10 of the first embodiment. In addition, the adhesive tape according to the fifth embodiment includes adhesive layers 110 and 120 that are laminated on both surfaces of the substrate 10 by a casting method, a coating method, or a gravure coating method. Alternatively, an adhesive layer 110 or 120 may be laminated on one surface of the substrate 10.

That is, the adhesive tape according to the fifth embodiment is manufactured by a process of preparing the substrate 10 by an electrospinning method, and then laminating the adhesive layers 110 and 120 on both surfaces of the substrate 10 or laminating the adhesive layer 110 or 120 on one surface of the substrate 10, in a variety of conventional ways.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

An adhesive tape that is one kind of a double-sided tape according to the present invention plays a role of making internal components mutually attached to each other in various electronic devices such as portable mobile terminals. When the adhesive tape according to the present invention is applied to portable mobile terminal, the portable mobile terminal may be made thin. As the adhesive tape according to the present invention has an excellent adhesive strength, components can be firmly fixed to each other.

1. An adhesive tape comprising:
a substrate; and
an adhesive layer laminated on one surface or both surfaces of the substrate,
wherein one or both of the substrate and the adhesive layer are produced in a nano-web form in which fiber strands are captured by a spinning method.

2. The adhesive tape of claim 1, wherein any one of general electrospinning, air-electrospinning (AES), electrospray, electrobrown spinning, centrifugal electrospinning, and flash-electrospinning is used as the spinning method.

3. The adhesive tape of claim wherein a plurality of pores are formed in the substrate, and an adhesive material for producing adhesive layers is injected into the plurality of pores.

4. The adhesive tape of claim 3, wherein the adhesive layers comprise a first adhesive layer that is stacked on one surface of the substrate, and a second adhesive layer that is stacked on the other surface of the substrate, in which the adhesive material that is obtained by mixing an adhesive and a solvent to have a viscosity sufficient for spinning is spun by using an electrospinning method.

5. The adhesive tape of claim 4, wherein a first release film is attached on the surface of the first adhesive layer, and a second release film is attached on the surface of the second adhesive layer, and wherein an attachment force between the first release film and the first adhesive layer, and an attachment force between the second release film and the second adhesive layer differ from each other.

6. The adhesive tape of claim 5, wherein the first release film and the second release film are formed of a different material from each other, in order to make the first release film and the second release film have a different adhesive strength from each other.

7. The adhesive tape of claim 1, wherein diameters of the fiber strands are in the range of 0.1˜3.0 μm.

8. The adhesive tape of claim 1, wherein a PET (Polyethylene terephthalate) film or a non-woven fabric is used as the substrate, and wherein an adhesive layer is formed on a surface of the PET film or the non-woven fabric, or the adhesive layers are respectively formed on both surfaces of the PET film or the non-woven fabric.

9. The adhesive tape of claim 1, wherein the substrate is formed in a nano-web shape having a plurality of pores by a spinning method, and the adhesive layer is laminated on a surface of the substrate by a casting method or a gravure coating method.

10. The adhesive tape of claim 1, further comprising a non-pore film layer laminated between the substrate and the adhesive layer, wherein the non-pore film layer is formed by electrospinning a polymer material containing PU (Polyurethane) or TPU (Thermoplastic polyurethane) in a form having no pores.

11. The adhesive tape of claim 1, wherein the adhesive layer is configured to comprise: a third adhesive layer that is laminated on one surface or both surfaces of the substrate; and a fourth adhesive layer that is laminated on a surface of the third adhesive layer, and when the third adhesive layers have a relatively high viscosity, respectively, in order to minimize absorption of the substrate into the pores and the fourth adhesive layer have a relatively lower viscosity than the third adhesive layers in order to reinforce the adhesive strength.

12. A method of manufacturing an adhesive tape, the method comprising:
forming a first adhesive layer by electrospinning an adhesive material;
forming a substrate by electrospinning a polymer material on a surface of the first adhesive layer; and
forming a second adhesive layer by electrospinning the adhesive material on a surface of the substrate.

13. The method of claim 12, wherein the forming the first adhesive layer and the forming the second adhesive layer comprise spinning fiber strands on one surface or both surfaces of the substrate to thereby form the first adhesive layer and the forming the second adhesive layer in a film shape, respectively.

14. The method of claim 12, wherein the forming the first adhesive layer and the forming the second adhesive layer comprise spinning a high viscosity of an adhesive material to thereby form a third adhesive layer and spinning a low viscosity of an adhesive material onto a surface of the third adhesive layer in comparison with the viscosity of the third adhesive layer to thereby form a fourth adhesive layer.

15. A method of manufacturing an adhesive tape, the method comprising:
preparing a substrate made of a non-woven fabric or non-pore type resin film;
forming a first adhesive layer by spinning an adhesive material on one surface of the substrate; and
forming a second adhesive layer by spinning the adhesive material on the other surface of the substrate.

16. A method of manufacturing an adhesive tape, the method comprising:
forming a substrate by electrospinning a polymer material;
forming a non-pore substrate that is laminated on one surface or both surfaces of the substrate; and
forming an adhesive layer by spinning an adhesive material on a surface of the non-pore film layer.
